(19) United States
(12) Patent Application Publication
(10) Pub. No.: US 2012/0312267 A1
(43) Pub. Date: Dec. 13, 2012

(54) Laser ignition system

(76) Inventor: Heiko Ridderbusch, Schwieberdingen (DE)

(21) Appl. No.: 13/515,771

(22) PCT Filed: Oct. 19, 2010
(86) PCT No.: PCT/EP2010/065697

§ 371 Date: Aug. 27, 2012

(30) Foreign Application Priority Data
Dec. 14, 2009 (DE) 10 2009 054 601.4

(51) Int. Cl. F02P 23/00

(52) U.S. Cl. 123/143 B

(57) ABSTRACT

A laser device for a laser ignition system for an internal combustion engine, in particular of a motor vehicle or a stationary engine, including a laser oscillator, the laser oscillator having a first laser-active solid, an optical Q-switch, and an output mirror which is partially reflective for a light to be generated by the laser device, in which the laser oscillator has another mirror which is partially reflective for the light to be generated by the laser device.

### FIELD OF THE INVENTION

The present invention is directed to a laser device. The present invention also relates to a corresponding laser ignition device and a method for operating a laser ignition device.

### BACKGROUND INFORMATION

An ignition device, which includes a laser device having a laser-active solid, for an internal combustion engine is discussed in WO 2006/125685 A1. The laser device further includes an input mirror, an output mirror, and a passive Q-switch. Here, the input mirror is highly reflective for the wavelength of the laser light, and the output mirror is partially reflective for the wavelength of the laser light so that the laser-active solid emits a highly energetic laser pulse through the output mirror after optical excitation of the laser-active solid and after the bleaching out of the passive Q-switch. Subsequently, the emitted laser pulse is available for igniting a fuel/air mixture.

This laser device has the disadvantage that only one highly energetic laser pulse is made available after the bleaching out of the passive Q-switch. Although in principle, another laser pulse may be emitted through the output mirror after new pumping of the laser-active solid and after new bleaching out of the passive Q-switch, the time lag between these laser pulses is, however, in many cases too large to have a favorable effect on the function of an ignition system during a power stroke of the internal combustion engine.

### SUMMARY OF THE INVENTION

Laser devices according to the present invention and laser ignition systems according to the present invention having the features described herein have the advantage over the related art that multiple highly energetic laser pulses may be provided at a small but defined time lag, e.g., in the range of one hundred picoseconds or one nanosecond. In this way, it is possible to apply multiple laser pulses during one power stroke of an internal combustion engine, and to thus improve the ignition behavior of the internal combustion engine.

The exemplary embodiments and/or exemplary methods of the present invention provide that the laser device includes at least two mirrors which are partially reflective for the light to be generated by the laser device. Thus, after supplying the pumped light and after bleaching out of the optical Q-switch, a radiation field, which is partially reflected and partially output at these mirrors, circulates inside the laser oscillator. In this way, the laser pulses are emitted very precisely at the same time.

Subsequently, the arrival of these laser pulses at one or multiple point(s) in the combustion chamber of an internal combustion engine may be indicated very precisely based on the optical path covered.

The mirrors which are partially reflective for the light to be generated by the laser device, also referred to in the following as partially reflective mirrors, are in the present case understood as mirrors which reflect 25% to 90%, in particular 40% to 80%, of this light. In differentiation to these mirrors, mirrors which reflect even more of this light, in particular more than 95%, are referred to as highly reflective mirrors.

One refinement of the exemplary embodiments and/or exemplary methods of the present invention provides that the laser device includes at least one laser amplifier which includes a second laser-active solid. The laser amplifier is used to amplify at least one of the laser pulses emitted by the laser oscillator.

Advantageously, not all laser pulses emitted by the laser oscillator are, however, amplified, but rather only those which exit the laser oscillator through one or multiple selected partially reflective mirrors. A laser device for an ignition device is thus made available, the laser device being able to particularly energetically provide, in a spatially and/or temporally selective manner, individual laser pulses of the laser pulses applied in a combustion chamber.

In an alternative or additional advantageous refinement of the exemplary embodiments and/or exemplary methods of the present invention, it is provided that the laser device includes a highly reflective mirror. With the aid of this mirror, it is possible in a low-loss manner to deflect the laser pulses, which initially propagate into different directions, in particular in such a way that they propagate coaxially to one another.

It is particularly advantageous that the laser device includes a laser amplifier, which includes a second laser-active solid, a highly reflective mirror being situated on a side of the laser amplifier facing away from the laser oscillator, or on a side of the second laser-active solid facing away from the laser oscillator.

A side of the laser amplifier or of the second laser-active solid facing away from the laser oscillator is understood as the side which is reached by a laser pulse emitted by the laser oscillator, after the laser pulse has traversed the laser amplifier or the second laser-active solid.

A configuration of this type has the advantage that the laser pulse passes through the laser amplifier or the second laser-active solid for a second time, this time in the opposite direction, and experiences an additional amplification in the process.

In a configuration of this type, it is possible in an advantageous refinement of the present invention to supply pumped light to the second laser-active solid through the highly reflective mirror. The pumped light transmitted through the second laser-active solid may be used to pump the first laser-active solid.

If the returning laser pulse is, in turn, reflected back into itself by a partially reflective mirror, further circulations in the amplifier are possible and the energy stored in the amplifier is made even better use of. This partially reflective mirror may be a mirror of the laser amplifier or a mirror of the second laser-active solid which is located on the side facing the laser oscillator. The partially reflective mirror may, however, also be the other reflective mirror of the laser oscillator through which the now amplified laser pulse was originally emitted from the laser oscillator. The amplified laser pulse is then already coaxially superimposed on the laser pulse which has left the laser oscillator through the partially reflective output mirror. Due to the repeated circulation in the laser amplifier of the laser pulse to be amplified, which is possible in this configuration, depending on the pulse duration of the laser pulse emitted directly by the laser oscillator, on the reflectivity of the partially reflective mirrors, and on optical path lengths, it either happens that the pulse duration of the amplified laser pulse is greater than the pulse duration of the laser pulse emitted directly by the laser oscillator or that the laser amplifier emits multiple amplified laser pulses through the other partially reflective mirror after each emission of the laser oscillator. The time lag between these pulses then corresponds to the time duration a laser pulse needs to travel from the other partially reflective mirror to the highly reflective mirror and back.

In an advantageous refinement of the present invention, measures are to be provided to ensure that a bleaching out of the optical Q-switch takes place, when the laser device is acted on by the pumped light, before a population inversion, which corresponds to a laser threshold, occurs within the second laser-active solid. In this way, it is avoided that a laser mode starts oscillating on its own within the amplifier.

Such measures may concern the power density of pumped light in the first and/or in the second laser-active solid(s). It is particularly advantageous to supply the laser device with pumped light which is focused in the laser oscillator and/or defocused in the laser amplifier.

A monolithic embodiment of the laser oscillator and/or of the laser amplifier improves the mechanical robustness of the system. For this purpose, one mirror or all mirrors may be applied as a reflective coating on the first and/or the second laser-active solid(s) and/or on the optical Q-switch. Additionally or alternatively, it is possible to monolithically connect the first laser-active solid to the optical Q-switch, in particular by optical contacting, bonding and/or sintering.

The laser oscillator may also be connected to the laser amplifier to form a monolithic unit, in particular by optical contacting, bonding and/or sintering. Here, it has proven advantageous to protect one or multiple reflective coatings present on the end faces to be connected using an SiO₂-containing intermediate layer, in particular an intermediate layer made of SiO₂ situated between the laser oscillator and the laser amplifier.

### BRIEF DESCRIPTION OF THE DRAWINGS

FIG. 1 shows a schematic representation of an internal combustion engine having a laser ignition device.

FIGS. 2a, 2b, and 2c show different specific embodiments of the present invention.

FIGS. 3a and 3b schematically show the intensity curve of the laser radiation emitted by a laser device according to the present invention.

### DETAILED DESCRIPTION

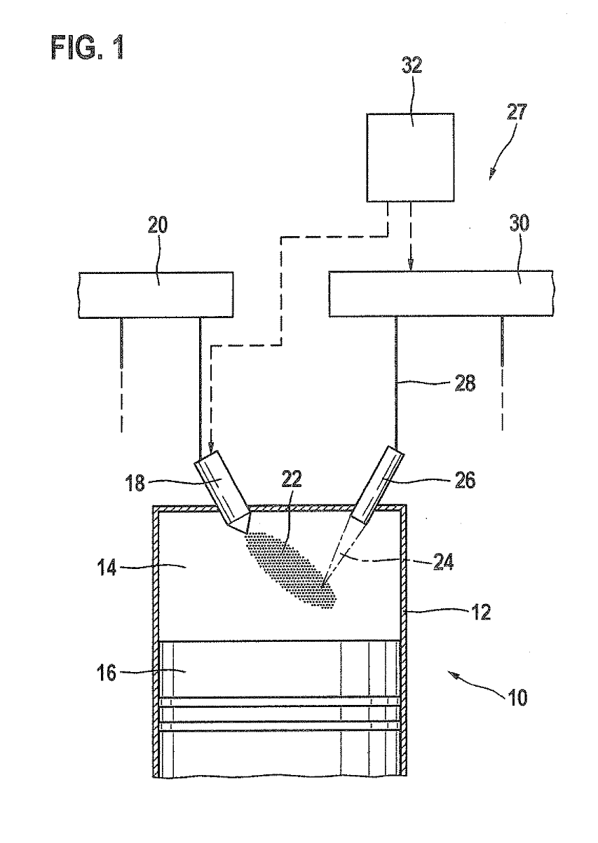

In FIG. 1, an internal combustion engine is identified as a whole by reference numeral 10. It is used for driving a motor vehicle (not illustrated) or as a stationary engine. Internal combustion engine 10 includes multiple cylinders, only one of which is labeled with reference numeral 12 in FIG. 1. A combustion chamber 14 of cylinder 12 is delimited by a piston 16. Fuel reaches combustion chamber 14 directly through an injector 18, which is connected to a fuel pressure accumulator 20.

Fuel 22 injected into combustion chamber 14 is ignited with the aid of at least one laser pulse 24 which is emitted into combustion chamber 14 by an ignition device 27 which includes a laser device 26. For this purpose, laser device 26 is supplied, via fiber optic device 28, with a pumped light provided by a pumped light source 30. Pumped light source 30 is controlled by a control and regulating device 32, which also activates injector 18.

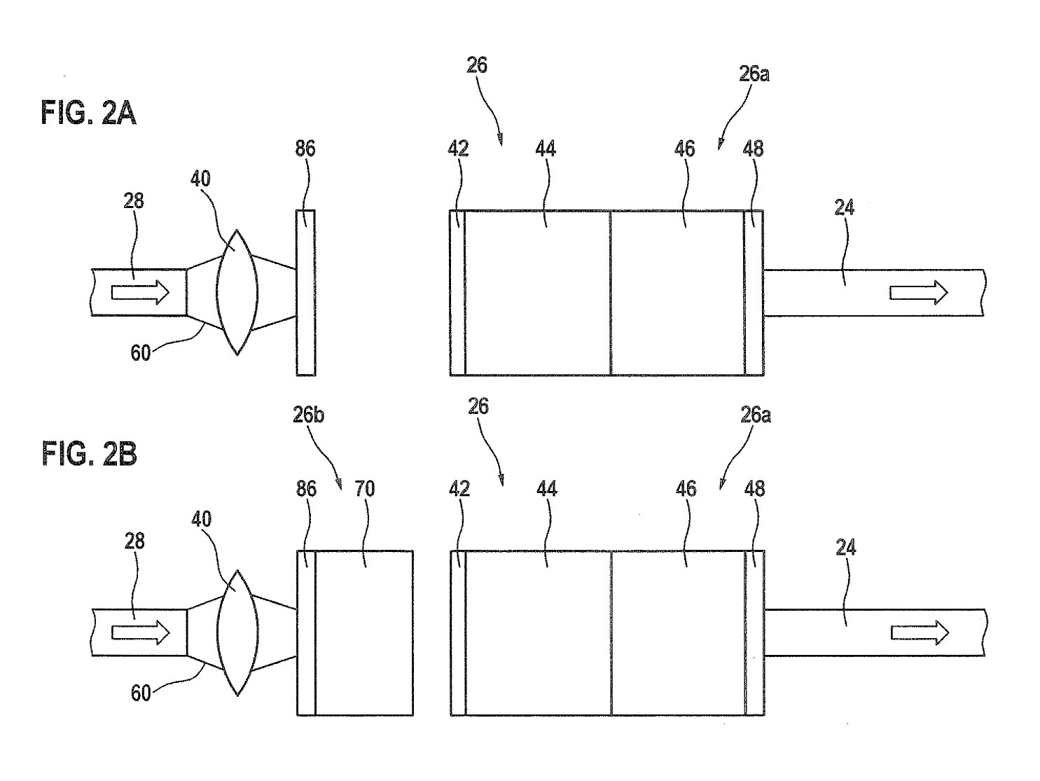

A first specific embodiment of a laser device 26 according to the present invention is illustrated in FIG. 2a and includes a laser oscillator 26a which, in turn, includes a first laser-active solid 44, an optical Q-switch 46, as well as an output mirror 48 and another mirror 42.

First laser-active solid 44 is, for example, an Nd:YAG crystal, and optical Q-switch 46 is, for example, a Cr:YAG crystal which is connected monolithically, for example by optical contacting and bonding, to first laser-active solid 44. Output mirror 48 is implemented by a dielectric coating of optical Q-switch 46. It has a reflectivity of 75% for light of a 1064 nm wavelength. The other mirror 42 is implemented by a dielectric coating of first laser-active solid 44. It also has a reflectivity of 75% for light of a 1064 nm wavelength and is in addition highly transmitting for light of a 808 nm wavelength, i.e., only minor losses occur when light of this wavelength is transmitted from the air into first laser-active solid 44. The reflective surfaces of output mirror 48 and of the other mirror 42 are flat and situated in parallel to one another in this example. It is, however, also possible to form in a manner known per se an optical resonator using curved mirrors 42, 48. It is also conceivable in principle to provide additional resonator mirrors, e.g., in a folded design or in a ring resonator, in particular in a nonplanar ring oscillator.

Laser device 26 is supplied with pumped light 60 via a fiber optic device 28, for example via an optical fiber or a bundle of optical fibers, and via a focusing optical system 40; the pumped light is focused within laser-active solid 44. Pumped light 60 is in this example light of a 808 nm wavelength and is made available by a pumped light source 30, for example a semi-conductor laser. Between focusing optical system 40 and laser oscillator 26a, a highly reflective mirror 86, whose reflective surface is also flat and situated in parallel to the reflective surface of the other mirror 42, is situated spaced apart from laser oscillator 26a. As an alternative to this example, those skilled in the art will consider using a curved and/or tilted highly reflective mirror 86. Highly reflective mirror 86 has a high reflectivity (for example, 98% or more) for light of a 1064 nm wavelength and is, in addition, highly transmitting for light of a 808 nm wavelength.

Of course, it is also conceivable that pumped light 60 is supplied longitudinally from the opposite side or that pumped light 60 is supplied transversally to the first laser-active solid.

To operate the laser device, pumped light 60 is, for example, applied in the form of a 300 μs-long pumped light pulse, so that a population inversion is formed inside first laser-active solid 44. As a consequence of the bleaching out of optical Q-switch 46 associated therewith, an intensive radiation field is formed inside laser oscillator 26a. On the one hand, this radiation field exits laser oscillator 26a in the form of a first laser pulse directly through output mirror 48 according to this mirror's transmission of the generated light.

On the other hand, the radiation field also exits the inside of laser oscillator 26a in the form of another laser pulse through the other mirror 42 according to this mirror's transmission of the generated light.

In this example, the first and the other laser pulse initially propagate in opposite directions to one another. However, while the first laser pulse is supplied directly to a combustion chamber 14 for the purpose of igniting a fuel/air mixture 22, the other laser pulse is deflected at highly reflective mirror 86 and subsequently propagates in the opposite direction, i.e., coaxially to the propagation direction of the first laser pulse. In the following, the other laser pulse is partially directly transmitted through laser oscillator 26a and is partially reflected back at partially reflective mirrors 42, 48. Ultimately, the radiation quantity corresponding to the second laser pulse, stretched over time compared to the first laser pulse, is supplied to the combustion chamber through output mirror 48.

In particular, it is possible to supply the first and the second laser pulses to the same location in the combustion chamber. For this purpose, the propagation directions of the laser pulses are identical up to 2° and/or the foci associated with the laser pulses coincide, i.e., they are laterally/transversely no more than two Rayleigh lengths (in particular no more than one Rayleigh length)/no more than two focal diameters (in particular no more than one focal diameter) apart.

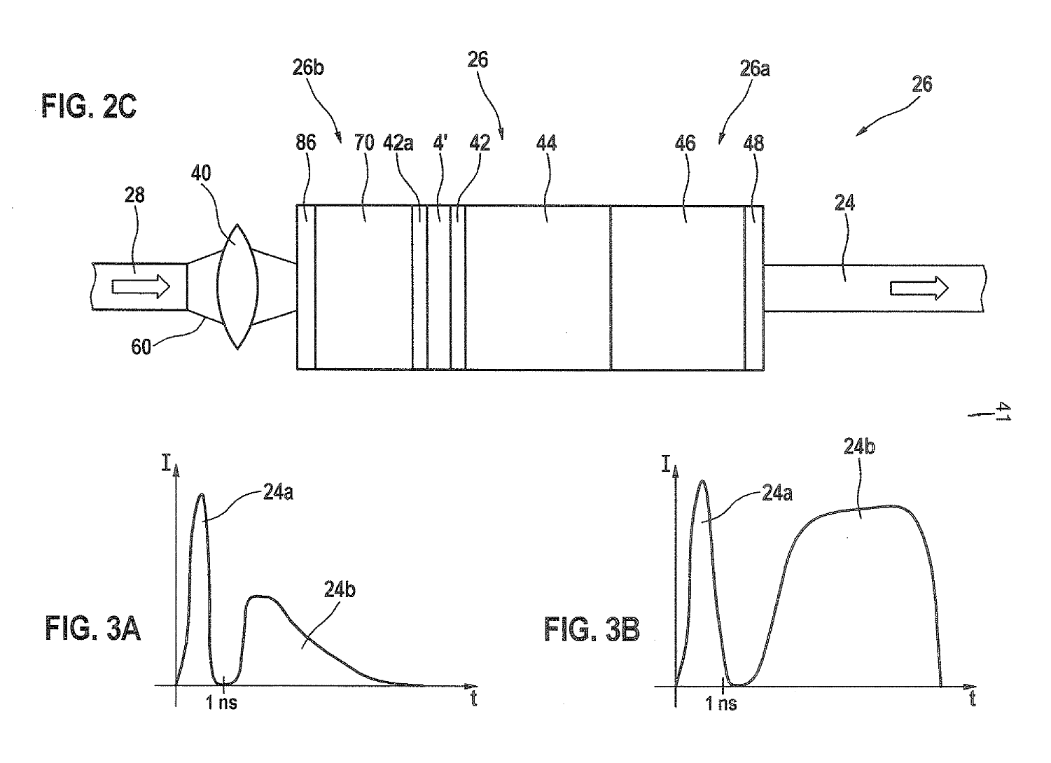

FIG. 3a shows an intensity curve over time of the light emitted from laser oscillator 26a in the direction of combustion chamber 14. Following first laser pulse 24a, the other laser pulse 24b is also emitted, however stretched over time and with a lower peak intensity than first laser pulse 24a.

In this example, a plasma is ignited in combustion chamber 14 with the aid of the first laser pulse, which is favored by this laser pulse's high peak intensity. The radiation emitted into combustion chamber 14 following the first laser pulse is to a large part absorbed in this plasma, thus increasing the energy content stored in the plasma to such an extent that an ignition of a fuel/air mixture in the combustion chamber starting from the plasma is ensured even under unfavorable operating conditions of the internal combustion engine.

A second specific embodiment of a laser device 26 according to the present invention is illustrated in FIG. 2b and includes a laser oscillator 26a and a laser amplifier 26b.

Laser oscillator 26a includes, just as in the first specific embodiment, a first laser-active solid 44, an optical Q-switch 46, as well as an output mirror 48 and another mirror 42. Laser oscillator 26a may match laser oscillator 26a from the first specific embodiment; however, it preferably differs therefrom in that the reflectivity of output mirror 48 for light of a 1064 nm wavelength is only between 55% and 65%, and the reflectivity of the other mirror 42 for light of a 1064 nm wavelength is up to 80%.

As in the first specific embodiment, laser device 26 is supplied with pumped light 60 via a fiber optic device 28, for example via an optical fiber or a bundle of optical fibers, and via a focusing optical system 40; the pumped light is focused within laser-active solid 44. The pumped light is light of a 808 nm wavelength and is provided by a pumped light source 30, for example by a semi-conductor laser.

Between focusing optical system 40 and laser oscillator 26a, laser amplifier 26b, which includes a second laser-active solid 70 and a highly reflective mirror 86, is situated spaced apart from laser oscillator 26a, for example.

Second laser-active solid 70 may be designed as first laser-active solid 44; it may, however, also differ therefrom with regard to the host lattice and doping, for example, as long as it is capable of amplifying the light generated by laser oscillator 26a.

Highly reflective mirror 86 is situated on the side of second laser-active solid 70 lying opposite laser oscillator 26a and may be applied to this side of second laser-active solid 70 in the form of a dielectric coating. The reflective surface of highly reflective mirror 86 is, for example, flat and situated in parallel to the reflective surface of the other mirror 42 and has a high reflectivity for light of a 1064 nm wavelength (for example, 98%) and is moreover highly transmitting to light of a 808 nm wavelength. As an alternative to this example, those skilled in the art will consider using a curved and/or tilted highly reflective mirror 86.

In this specific embodiment, the laser device is supplied longitudinally with pumped light 60 in such a way that it initially reaches laser amplifier 26b, and subsequently the portions of pumped light 60, which are not absorbed in second laser-active solid 70, reach first laser-active solid 44. Of course, it is also conceivable that pumped light 60 is supplied longitudinally from the opposite side or that pumped light 60 is supplied transversally to first laser-active solid 44 or to second laser-active solid 70. A combination of these possibilities is in principle also conceivable.

To operate a laser device 26 according to the second specific embodiment, pumped light 60 is, for example, applied in the form of a 400 μs-long pumped light pulse, so that a population inversion is formed inside first and second laser-active solid 44, 70. As a consequence of the bleaching out of optical Q-switch 46, an intensive radiation field is formed inside laser oscillator 26a. On the one hand, this radiation field exits laser oscillator 26a directly through output mirror 48 (first laser pulse), and, on the other hand, through the other mirror 42 (the other laser pulse) according to the transmissions of mirrors 42, 48.

The first and the other laser pulses initially propagate in opposite directions to one another. However, while the first laser pulse is supplied directly to combustion chamber 14 for the purpose of igniting a fuel/air mixture 22, the other laser pulse is amplified in laser amplifier 26b, then deflected at highly reflective mirror 86, and subsequently amplified again during its second pass through second laser-active solid 70 in the opposite direction. In the following, the other laser pulse is partially directly transmitted through laser oscillator 26a and is partially reflected back at partially reflective mirrors 42, 48. For this purpose, the energy deposited in second laser-active solid 70 is transferred gradually and largely completely to the radiation field of the other laser pulse. The other laser pulse is overall amplified and stretched over time compared to the first laser pulse. The other laser pulse is subsequently supplied to the combustion chamber through output mirror 48.

In particular, it is provided to supply the first and the second laser pulses to the same location in the combustion chamber. For this purpose, the propagation directions of the laser pulses are identical up to 2° and/or the foci associated with the laser pulses coincide, i.e., they are laterally/transversely no more than two Rayleigh lengths (in particular no more than one Rayleigh length)/no more than two focal diameters (in particular no more than one focal diameter) apart.

FIG. 3b shows an intensity curve over time of the light emitted from laser oscillator 26a in the direction of combustion chamber 14. Following first laser pulse 24a, the other laser pulse 24b is also emitted. In this example, the peak intensity of first laser pulse 24a is higher, but the energy content is lower than in the case of second laser pulse 24b.

The generated laser radiation may be advantageously used in such a way that a plasma is ignited in combustion chamber 14 with the aid of the first laser pulse, which is favored by this laser pulse's high peak intensity. The radiation emitted into combustion chamber 14 following the first laser pulse is to a large part absorbed in this plasma, thus increasing the energy content stored in the plasma to such an extent that an ignition of a fuel/air mixture in the combustion chamber starting from the plasma is ensured even under unfavorable operating conditions of the internal combustion engine.

Another specific embodiment of the present invention, which is illustrated in FIG. 2c, differs from the previous one in that laser device 26, including laser oscillator 26a and laser amplifier 26b, has a monolithic design.

In principle, this is possible directly, for example, by optical contacting and subsequent sintering or bonding. To protect one or multiple reflective coating(s) 42, 42a applied on one or multiple laser-active solid(s) 44, 70, it has, however, proven advantageous to provide a SiO₂-containing layer, in particular a layer made of SiO₂, between laser-active solids 44, 70 or between laser oscillator 26a and laser amplifier 26b.

1-16. (canceled)

17. A laser device for a laser ignition system for an internal combustion engine of a motor vehicle or a stationary engine, comprising:
a laser oscillator having a first laser-active solid, an optical Q-switch, and an output mirror which is partially reflective for a light to be generated by the laser device, wherein the laser oscillator has another mirror which is partially reflective for the light to be generated by the laser device.

18. The laser device of claim 17, wherein the partially reflective output mirror and the partially reflective mirror are situated on opposite sides of the first laser-active solid or the laser oscillator.

19. The laser device of claim 17, further comprising:
a laser amplifier having at least one second laser-active solid.

20. The laser device of claim 19, wherein the laser amplifier has a mirror, which is highly reflective for the light to be generated by the laser device, on a side facing away from the laser oscillator.

21. The laser device of claim 20, wherein the highly reflective mirror forms, together with at least one mirror which is partially reflective for the light to be generated by the laser device, an optical resonator in which the second laser-active solid is located.

22. The laser device of claim 20, wherein the highly reflective mirror forms, together with a mirror of the laser oscillator, an optical resonator in which the second laser-active solid is located.

23. The laser device of claim 17, wherein the partially reflective output mirror is a coating of the first laser-active solid or of the optical Q-switch and/or the other partially reflective mirror is a coating of the first laser-active solid.

24. The laser device of claim 20, wherein the other partially reflective mirror is a coating of the first or the second laser-active solid and/or the highly reflective mirror is a coating of the second laser-active solid.

25. The laser device of claim 19, wherein the first and the second laser-active solids represent a monolithic unit, implemented by optical contacting, sintering and/or bonding.

26. The laser device of claim 25, wherein an SiO₂-containing intermediate layer is situated between the first and the second laser-active solids, the SiO₂-containing intermediate layer being furthermore connected to at least one of the coatings applied to the first or the second laser-active solid.

27. A laser ignition system for an internal combustion engine of a motor vehicle or a stationary engine, comprising:
a laser device, including a laser oscillator having a first laser-active solid, an optical Q-switch, and an output mirror which is partially reflective for a light to be generated by the laser device, wherein the laser oscillator has another mirror which is partially reflective for the light to be generated by the laser device; and
at least one pumped light source which provides a pumped light which is supplied to the laser device.

28. The laser ignition system of claim 27, wherein:
the laser device further including a laser amplifier having at least one second laser-active solid, wherein the laser amplifier has a mirror, which is highly reflective for the light to be generated by the laser device, on a side facing away from the laser oscillator, and
the pumped light is supplied to the laser device through the mirror which is highly reflective for the light to be generated by the laser device and which subsequently passes initially through the second laser-active solid and later through the first laser-active solid.

29. The laser ignition system of claim 28, further comprising:
a guiding light arrangement for guiding light through which the pumped light is transferred from the pumped light source to the laser device and focused within the laser device, within the laser oscillator.

30. A method for operating a laser ignition system having a laser device, the method comprising:
as a consequence of supplying pumped light to the laser device, bleaching out the optical Q-switch, so that, as a result of the bleaching out, a laser oscillator emits at least two laser pulses in different directions;
wherein the laser ignition system includes:
the laser device, including the laser oscillator having a first laser-active solid, an optical Q-switch, and an output mirror which is partially reflective for a light to be generated by the laser device, wherein the laser oscillator has another mirror which is partially reflective for the light to be generated by the laser device; and
at least one pumped light source which provides a pumped light which is supplied to the laser device.

31. The method of claim 30, wherein one of the at least two emitted laser pulses, which is emitted in a first direction, is focused onto a first point, and another of the at least two emitted laser pulses, which is emitted in another direction, is focused onto another point, the first point and the second point essentially matching and/or the second laser pulse propagating essentially coaxially to the first laser pulse following a deflection.

32. The method of claim 30, wherein a consequence of supplying pumped light to the laser device is a bleaching out of the optical Q-switch, without resulting directly beforehand in a population inversion corresponding to a laser threshold within the second laser-active solid.
